(19) United States
(12) Patent Application Publication
(10) Pub. No.: US 2015/0255090 A1
(43) Pub. Date: Sep. 10, 2015

(54) METHOD AND APPARATUS FOR DETECTING SPEECH SEGMENT

(71) Applicant: Samsung Electro-Mechanics Co., Ltd., Suwon-Si (KR)

(72) Inventor: Sang-Jin KIM, Suwon (KR)

(73) Assignee: SAMSUNG ELECTRO-MECHANICS CO., LTD., Suwon-Si (KR)

(21) Appl. No.: 14/641,784

(22) Filed: Mar. 9, 2015

(30) Foreign Application Priority Data
Mar. 10, 2014 (KR) 10-2014-0027899

(51) Int. Cl. G10L 25/84; G10L 15/20

(52) U.S. Cl. CPC G10L 25/84; G10L 15/20

(57) ABSTRACT

The present invention relates to a method and apparatus for detecting speech segment. Embodiments of the present invention provide a method for accurately detecting speech segment without going through the process of converting to a frequency domain, and apparatus thereof.

### CROSS REFERENCE TO RELATED APPLICATION

This application claims the benefit of Korean Patent Application No. 10-2014-0027899, filed on Mar. 10, 2014, entitled “Method and Apparatus for detecting speech segment”, which is hereby incorporated by reference in its entirety into this application.

### BACKGROUND

1. Technical Field

The present invention relates to a method and apparatus for detecting speech segment.

2. Description of the Related Art

Speech recognition is technology to extract and analyze speech features from human voice transmitted to a computer or a speech recognition system to find the closet result from a pre-determined recognition list. Here, speech feature extraction which extracts unique features of the speech as a quantified parameter is important for speech recognition. It requires to classify a speech signal into speech segment(s) and background noise (or silence) segment(s) for good speech feature extraction.

There are a short-term energy method and a zero crossing rate method as well-known methods for detecting speech segment but both should provide a threshold value depending on a signal in advance during the process of separating speech signals.

US Patent Publication No. 20120130713 (Title: Systems, methods and apparatus for voice activity detection) requires a lot of time for voice detection since it converts a speech signal into a frequency domain signal while detecting voice activity.

KR Patent Publication No. 1020130085732 (Title: A codebook-based speech enhancement method using speech absence probability and apparatus thereof) also requires a lot of time for voice detection and is difficult to apply into an actual system since it has tried to detect in a frequency domain and is based on codebook even though it detects using speech presence probability.

KR Patent Publication No. 1020060134882 (Title: A method for adaptively determining a statistical model for a voice activity detection) has tried for voice detection using a statistical model but adds burden to a system and requires excessive power consumption since it uses a fast Fourier transform so that it cannot be applied to a mobile device.

### SUMMARY

Embodiments of the present invention provide a method for accurately detecting speech segment without going through the process of converting to a frequency domain, and apparatus thereof.

Embodiments of the present invention provide a method for detecting speech segment which can reduce the burden on a processor and consumption by reducing calculation processes, and apparatus thereof.

Embodiments of the present invention provide a method for detecting speech segment which can be applied to a mobile device provided with a limited power, and apparatus thereof.

### BRIEF DESCRIPTION OF DRAWINGS

FIG. 1 is a flowchart illustrating a method for detecting speech segment according to an embodiment of the present invention.

FIG. 2 is a scheme illustrating that a speech signal is composed of background noise segment(s) and speech segment(s).

FIG. 3 illustrates calculating a mean and a standard deviation in a method for detecting speech segment according to an embodiment of the present invention.

FIG. 4 illustrates obtaining a frame and sub-frames according to an embodiment of the present invention.

FIG. 5 is a flowchart illustrating a method for detecting speech segment according to another embodiment of the present invention.

FIG. 6 illustrates obtaining a first frame and a second frame according to an embodiment of the present invention.

FIG. 7 illustrates detecting a starting time of the speech segment and an ending time of the speech segment according to an embodiment of the present invention.

FIG. 8 illustrates a simulation result of a method for detecting speech segment using a probabilistic model and hierarchical frame information of background noise according to an embodiment of the present invention.

FIG. 9 is a block view illustrating an apparatus for detecting speech segment using a probabilistic model and hierarchical frame information of background noise according to an embodiment of the present invention.

### DESCRIPTION OF THE EXEMPLARY EMBODIMENTS

The above and other objects, features and advantages of the present invention will become more apparent to those of ordinary skill in the art by describing in detail exemplary embodiments thereof with reference to the accompanying drawings. Throughout the description of the present invention, when describing a certain technology is determined to evade the point of the present invention, the pertinent detailed description will be omitted. The terms used hereinafter are defined by considering their functions in the present invention and can be changed according to the intention, convention, etc. of the user or operator.

However, it is to be understood that the present invention is not limited to a specific exemplary embodiment, but includes all modifications, equivalents, and substitutions without departing from the scope and spirit of the present invention. It is also to be understood that exemplary embodiments completes the teachings of the present invention to those of ordinary skill in the art. The scope of the present invention should be interpreted by the following claims and it should be interpreted that all spirits equivalent to the following claims fall with the scope of the present invention.

Hereinafter, exemplary embodiments of the present invention will be described in detail with reference to the accompanying drawings.

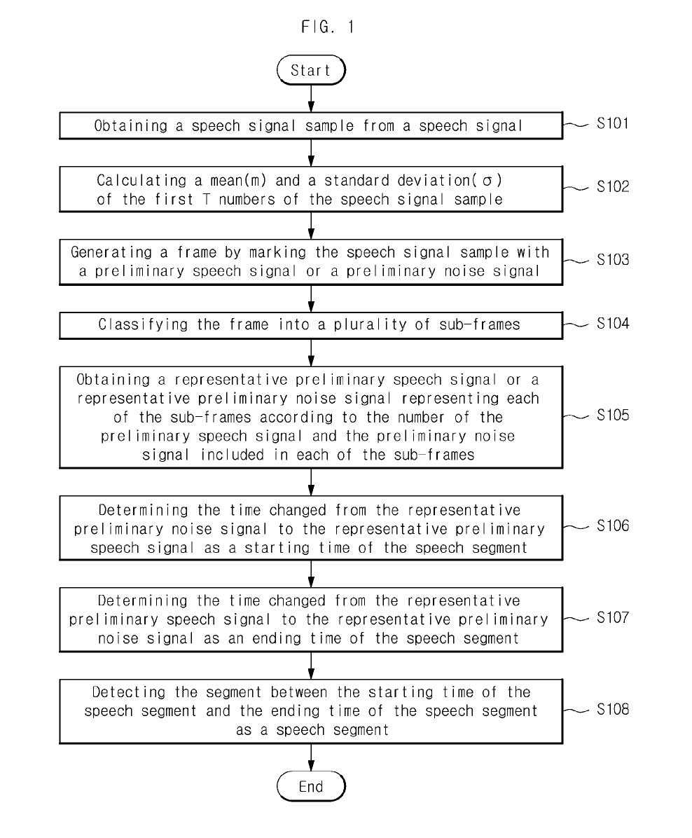

FIG. 1 is a flowchart illustrating a method for detecting speech segment according to an embodiment of the present invention.

A method for detecting speech segment according to an embodiment of the present invention may receive a speech signal including background noise segment(s) and speech segment(s) through a speech recognition unit 620. Here, the speech recognition unit 620 may be any means which can convert speech to an electrical signal.

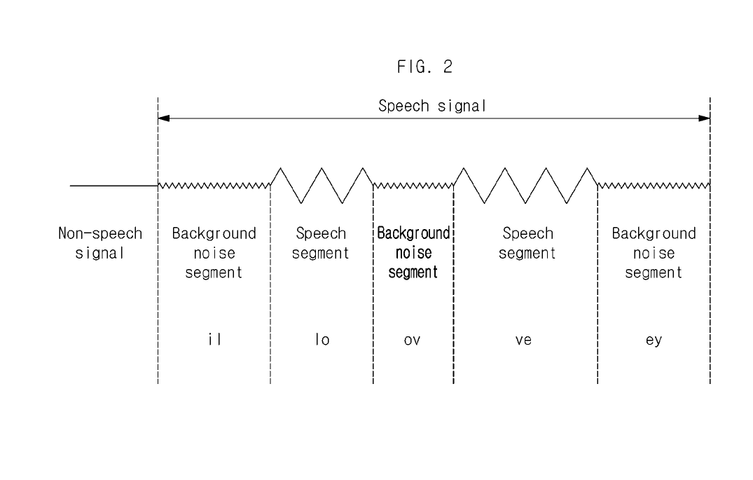

The speech signal received from the speech recognition unit 620 may include background noise segment(s) and speech segment(s). Referring to FIG. 2, the background noise segment is the segment which includes noise before the speech segment starts, but distinguished from a non-speech signal.

The speech segment is the segment which includes actual speech after the background noise segment. The speech signal essentially includes background noise segment(s) and speech segment(s). As shown in FIG. 2, the speech signal of ‘I love you’ requisitely includes a background noise signal of ‘il’ before the signal of ‘lo’, which is distinguished from a non-speech signal.

Background noise signals such as ‘ov’ between ‘lo’ and ‘ve’ are included.

A conventional invention is intended to distinguish a speech signal and a non-speech signal but a method for detecting speech segment according to an embodiment of the present invention is intended to distinguish background noise segment(s) and speech segment(s) included in a speech signal.

Referring to FIG. 1, in S101, a speech signal sample may be obtained from a speech signal.

The speech signal sample obtained in an embodiment of the present invention may be a sample for an amplitude of the speech signal. The number of the obtained sample may be also more than one.

The number of samples obtained in the method for detecting speech segment according to an embodiment of the present invention may vary with processing speed and capacity of a memory of a system.

In S102, a mean (m) and a standard deviation (σ) of the first T numbers of the speech signal sample obtained in S101 may be calculated.

As described above, the obtained speech signal sample may be a sample value for an amplitude of the speech signal. Since the speech signal requisitely includes background noise segment(s), the first T numbers of the speech signal sample may include speech signal sample(s) of background noise segment(s).

Here, the number T may be set differently based on environment where the method for detecting speech segment is executed.

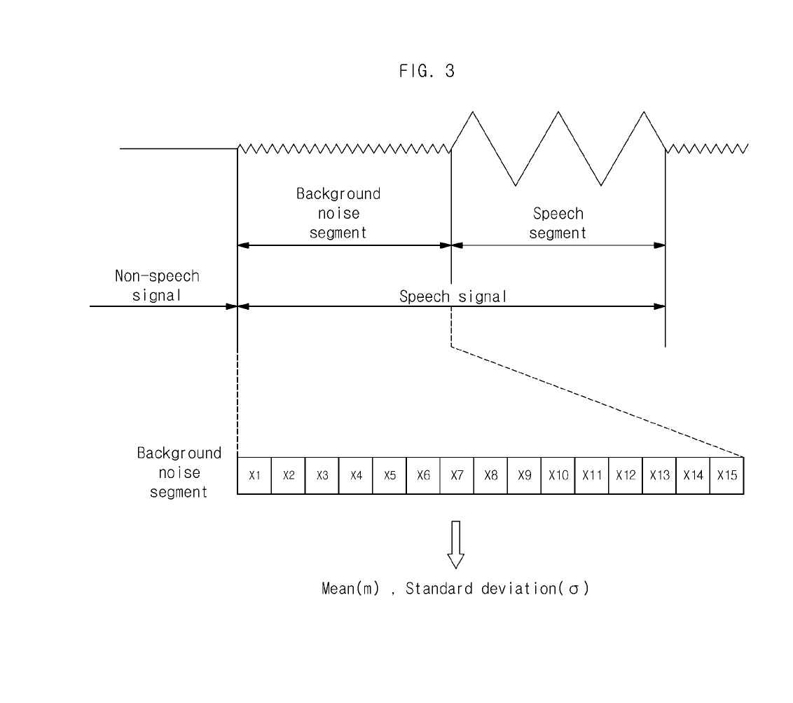

Referring to FIG. 3, it is noted that 15 sample values (X1,X2 . . . X14 and X15) are obtained from a background noise segment of a speech signal. Those sample values are uniformly obtained from all over the background noise segment but may be obtained from a part of the background noise segment.

In another embodiment, when a user specifies a criteria to distinguish a background noise segment with a certain numerical range, any speech signal which deviates the certain numerical range may be determined as a speech segment and the speech signal which is within the certain numerical range may be determined as a background noise segment. A mean (m) and a standard deviation (σ) of the sample included in the background noise segment may be then calculated.

A method for calculating a mean (m) and a standard deviation (σ) may be any known method.

As shown in FIG. 3, a mean (m) and a standard deviation (σ) of the speech signal included in the background noise segment sample is obtained by using 15 samples (X1, X2 . . . X14 and X15).

The mean (m) may be a mean of 15 samples X1,X2 . . . X14 and X15 and the standard deviation (σ) may be calculated by using the mean (m) and the 15 samples X1,X2 . . . X14 and X15.

Here, the standard deviation (σ) indicates a degree of deviation from the background noise. That is, when an absolute value of a value obtained by subtracting the mean (m) from any speech signal sample value is greater than the standard deviation (σ), it may be determined as that the signal is obtained from the speech segment.

In S103, a frame may be generated by marking the speech signal sample with a preliminary speech signal or a preliminary noise signal based on the mean (m) and the standard deviation (σ).

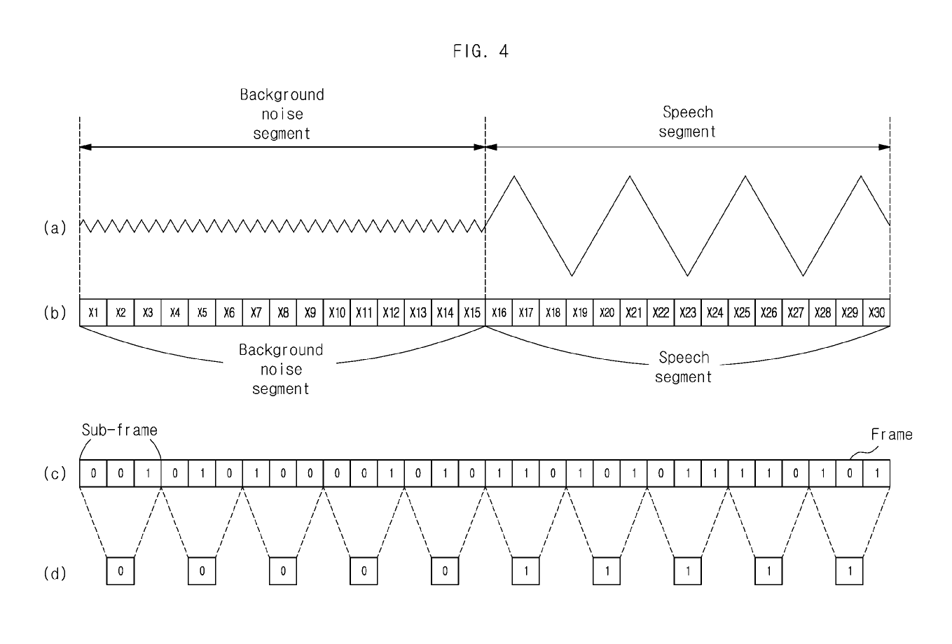

Referring to FIG. 4, a background noise segment sample may include X1, X2 . . . X14 and X15 and a speech segment sample may include X16, X17 . . . X29 and X30.

When an absolute value of a value obtained by subtracting a mean (m) from the sample value of the speech signal sample is equal to or greater than N real number multiples of a standard deviation (σ), it may be marked as a preliminary speech signal. Here, the preliminary speech signal may be marked with 1.

When an absolute value of a value obtained by subtracting a mean (m) from the sample value of the speech signal sample is less than N real number multiples of a standard deviation (σ), it may be marked as a preliminary noise signal. Here, the preliminary noise signal may be marked with 0.

In an embodiment, N may be any one selected from 1, 2, and 3 but it is not limited thereto. For example, according to the standard normal distribution, when N is 1, the speech segment may be the segment which deviates 68%, when N is 2, the speech segment may be the segment which deviates 95%, and when N is 3, the speech segment may be the segment which deviates 99.7%. N may vary with a user's request.

As shown in FIG. 4, when an absolute value of a value obtained by subtracting the mean (m) from the speech signal X1 is less than N real number multiples of the standard deviation (σ), it may be marked with 0. When an absolute value of a value obtained by subtracting the mean (m) from the speech signal X3 is equal to or greater than N real number multiples of the standard deviation (σ), it may be marked with 1.

When an absolute value of a value obtained by subtracting the mean (m) from the speech signal X16 is equal to or greater than N real number multiples of the standard deviation (σ), it may be marked with 1. When an absolute value of a value obtained by subtracting the mean (m) from the speech signal X18 is less than N real number multiples of the standard deviation (σ), it may be marked with 0.

A frame shown in FIG. 4 may be generated by applying this method for from X1 to X30.

In S104, the frame may be classified into a plurality of sub-frames.

X1, X2 and X3 is classified as one sub-frame in FIG. 4 and thus 30 samples may be classified into 10 sub-frames.

In S105, a representative preliminary speech signal or a representative preliminary noise signal representing each of the sub-frames may be obtained according to the number of the preliminary speech signal and the preliminary noise signal included in each of the sub-frames.

In FIG. 4, when X1, X2 and X3 are classified into one sub-frame, the number of 0 is since X1 is 0, X2 is 0, and X3 is 1. And thus, the representative preliminary noise signal representing the sub-frame including X1, X2 and X3 may be 0.

In another embodiment, when X16, X17 and X18 are classified into one sub-frame, the number of 1 is more since X16 is 1, X17 is 1, and X18 is 0. And thus, the representative preliminary speech signal representing the sub-frame including X16, X17 and X18 may be 1.

When this process is repeated and the representative signals from X1 to X30 are obtained, 5 representative preliminary noise signals which are 0 may be obtained from X1 to X15 and 5 representative preliminary speech signals which are 1 may be obtained from X16 to X30.

In S106, the time changed from the representative preliminary noise signal to the representative preliminary speech signal may be determined as a starting time of the speech segment.

In FIG. 4, it may be determined as that the time changed from the representative preliminary noise signal 0 representing X13, X14 and X15 to the representative preliminary speech signal 1 representing X16, X17 and X18 is a starting time of the speech segment.

More particularly, the time when X15 and X16 is obtained may be the starting time of the speech segment.

In S107, the time changed from the representative preliminary speech signal to the representative preliminary noise signal may be determined as an ending time of the speech segment.

In S108, the segment between the starting time and the ending time may be determined as a speech segment by using the starting time of the speech segment determined in S106 and the ending time of the speech segment determined in S107.

The method for detecting speech segment according to an embodiment of the present invention accurately detects the speech segment without the process for converting into a frequency domain and further reduces the burden on the processor and power consumption by reducing calculation processes so that it can be applied to a mobile device provided with a limited power.

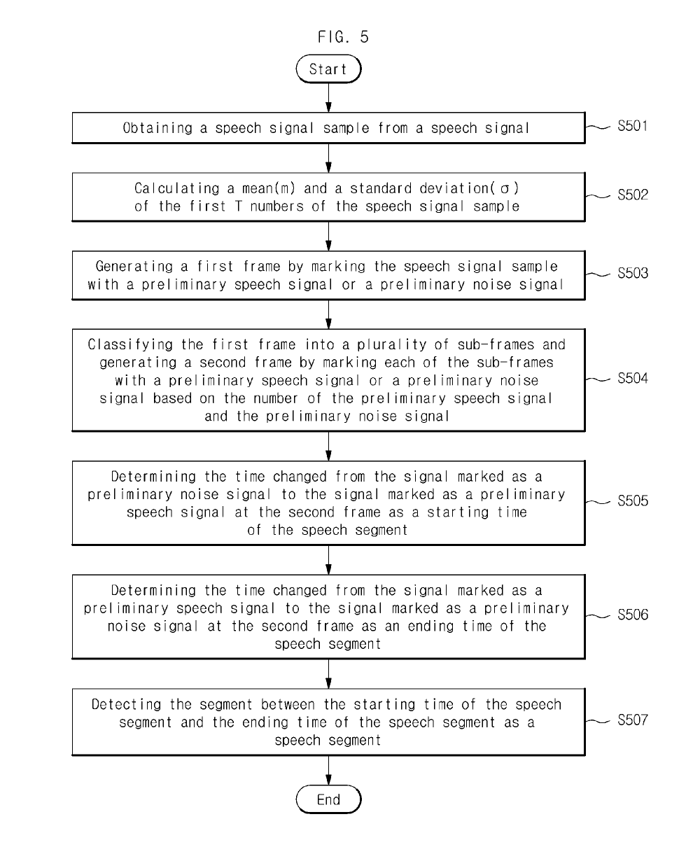

FIG. 5 is a flowchart illustrating a method for detecting speech segment according to another embodiment of the present invention.

Referring to FIG. 5, in S501, a speech signal including background noise segment(s) and speech segment(s) may be received.

In S502, a mean (m) and a standard deviation (σ) of the first T numbers of a speech signal sample may be calculated.

In S503, a frame may be generated by marking the speech signal sample with one selected from a preliminary speech signal and a preliminary noise signal based on the mean (m) and the standard deviation (σ).

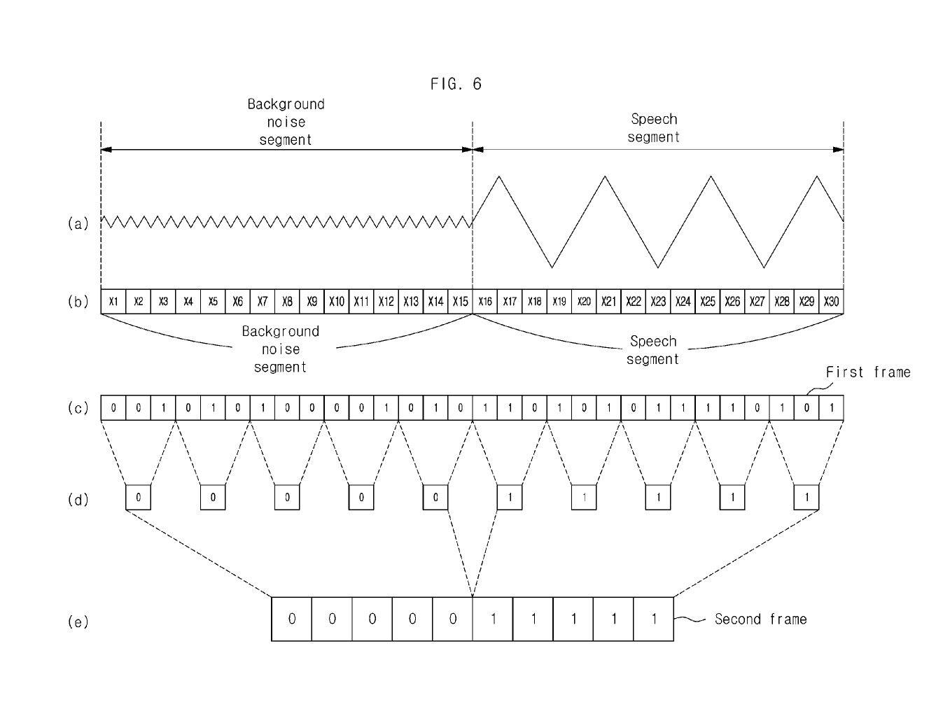

Referring to FIG. 6, a background noise segment sample may include X1, X2 . . . X14 and X15 and a speech segment sample may include X16, X17 . . . X29 and X30.

In an embodiment, when an absolute value of a value obtained by subtracting a mean (m) from the sample value of the speech signal sample is equal to or greater than N real number multiples of a standard deviation (σ), it may be marked as a preliminary speech signal. Here, the preliminary speech signal may be marked with 1.

When an absolute value of a value obtained by subtracting a mean (m) from the sample value of the speech signal sample is less than N real number multiples of a standard deviation (σ), it may be marked as a preliminary noise signal. Here, the preliminary noise signal may be marked with 0.

As shown in FIG. 6, when an absolute value of a value obtained by subtracting the mean (m) from the speech signal X1 is less than N real number multiples of the standard deviation (σ), it may be marked with 0. When an absolute value of a value obtained by subtracting the mean (m) from the speech signal X3 is equal to or greater than N real number multiples of the standard deviation (σ), it may be marked with 1.

When an absolute value of a value obtained by subtracting the mean (m) from the speech signal X16 is equal to or greater than N real number multiples of the standard deviation (σ), it may be marked with 1. When an absolute value of a value obtained by subtracting the mean (m) from the speech signal X18 is less than N real number multiples of the standard deviation (σ), it may be marked with 0.

A first frame shown in FIG. 6 may be generated by applying this method for from X1 to X30.

In S504, the first frame may be classified into a plurality of sub-frames. A second frame may be generated by marking each of the sub-frames with a preliminary speech signal or a preliminary noise signal based on the number of the preliminary speech signal and the preliminary noise signal.

In another embodiment, the first frame may be classified into a plurality of sub-frames and importance for each sub-frame may be determined. A second frame may be generated by marking each sub-frame as a preliminary speech signal or a preliminary noise signal based on the importance.

It is noted that X1 is 0, X2 is 0, and X3 is 1 in FIG. 6. X1, X2 and X3 are classified to one sub-frame and importance of the sub-frame including X1, X2 and X3 may be 0 since the number of 0 is more than that of 1.

When the importance of the sub-frame is 0, the frame representing the sub-frame including X1, X2 and X3 may be marked with 0 as shown in FIG. 6.

It is noted that X16 is 1, X17 is 1, and X18 is 0, and X16, X17 and X18 are classified to one sub-frame as shown in FIG. 6. Since the number of 1 is more, the importance of the sub-frame including X16, X17 and X18 may be 1.

When the importance of the sub-frame is 1, the frame representing the sub-frame including X16, X17 and X18 may be marked with 1 as shown in FIG. 6.

As shown in FIG. 6, a second frame may be generated by collecting frames representing each sub-frame. However, the importance may be determined according to a user's request in an embodiment of the present invention.

In the second frame of FIG. 6, it is noted that the frames corresponding to the background noise segment may be marked with 0 and the frames corresponding to the speech segment may be marked with 1.

It is described to perform the process for generating the first frame and the second frame only once herein but the process for generating the first frame and the second frame may be performed more than once depending on user's request, system's specification, characteristics of a speech signal and the like.

In S505, the time changed from the signal marked as a preliminary noise signal to the signal marked as a preliminary speech signal at the second frame may be determined as a starting time of the speech segment.

In S506, the time changed from the signal marked as a preliminary speech signal to the signal marked as a preliminary noise signal at the second frame may be determined as an ending time of the speech segment.

In S507, the segment between the starting time and the ending time may be determined as a speech segment.

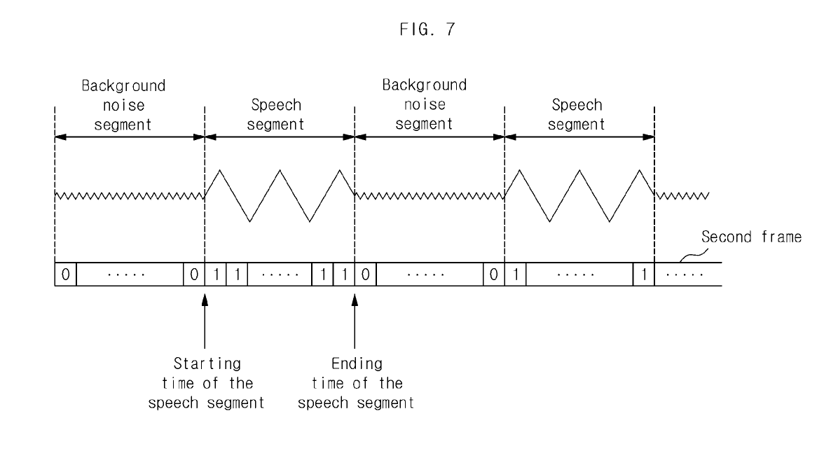

Referring to FIG. 7, the time changed from 0 to 1 at the second frame may be the starting time of the speech segment and the time changed from 1 to 0 may be the ending time of the speech segment.

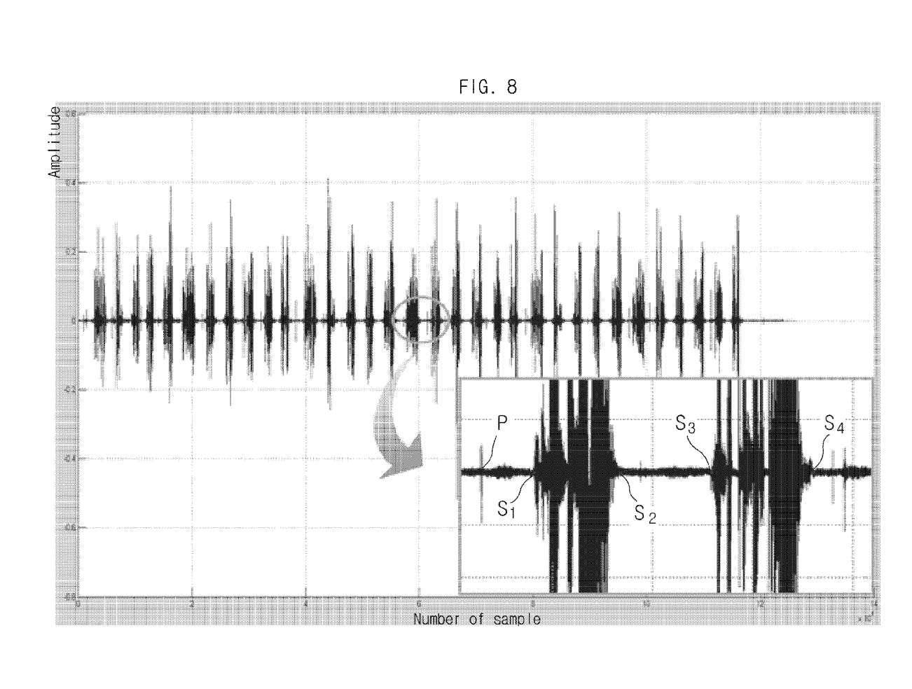

FIG. 8 illustrates a simulation result of a method for detecting speech segment using a probabilistic model and hierarchical frame information of background noise according to an embodiment of the present invention.

Referring to FIG. 8, the background noise segment is between P and S1 and the speech segment is between S1 and S2. A method for detecting speech segment according to the present invention may accurately detect that the speech segment starts at S1 where the background noise segment and the speech segment meet.

Furthermore, S2 is the ending time of the speech segment. A method for detecting speech segment according to the present invention may accurately detect the time changed from the speech segment to the background noise segment. S3 and S4 may be also detected by the same method.

Table 1 below compares a method for detecting speech segment using a probabilistic model of background noise and hierarchical frame information according to an embodiment of the present invention with conventional methods.

TABLE 1

| Phrase | STE | ZCR-based STE | Present invention |
|---|---|---|---|
| Number combination | 75.732% | 72.213% | 87.452% |
| Sentence | 48.214% | 51.129% | 68.564% |

STE is Short Time Energy and ZCR-based STE is zeros crossing rate (ZCR) which are well known in the art. As shown in Table 1, it is noted that a method for detecting speech segment using a probabilistic model of background noise and hierarchical frame information according to an embodiment of the present invention shows better results, compared to conventional methods.

Methods or algorithm steps in exemplary embodiments described hereinabove may be implemented by using hardware, software or its combination. When they are implemented by software, they may be implemented as software executing in more than one processors. The software module may be included in a RAM memory, a flash memory, a ROM memory, an EPROM memory, an EEPROM memory, a register, a hard disk, a removable disk, CD-ROM, or a storing media known in the art of the present invention. The storing media may be combined with the processor and the processor may thus read information from the storing media and record information to the storing media.

Alternatively, the storing media may be integrated with the processor. The processor and the storing media may be installed in ASIC. The ASIC may be installed in a user's terminal. In addition, the processor and the storing media may be installed as separate components in a user's terminal.

All processors described hereinabove may be implemented in one or more general purpose or special purpose computers or software code modules executable by the processor and be completely automated through the software code module. The code module may be stored in any type of a computer readable medium or another computer storage device or a set of storage devices. A part or all of the methods may be alternatively implemented in specialized computer hardware.

All methods and tasks described above may be executed and fully automated by a computer system. The computer system may include multiple individual computers or computing devices(for example, physical servers, workstations, storage arrays, and the like) which communicate and interact each other through network to perform the functions described above.

Each computing device may include program instructions stored in a memory or a non-transitory computer readable storing medium or a processor (or multiple processors or a circuit or a set of circuits, for example, module) executing modules.

A part or all of various functions described herein may be implemented by application-specific circuits (for example, ASICs or FPGAs) of a computer system but the described various functions may be implemented by such program instructions. When the computer system includes one or more computing devices, the devices may be arranged at the same place but it is not limited thereto. Results of all methods and tasks described above may be permanently stored by interchangeable storage devices such as solid state memory chips and/or magnetic disks in different formats.

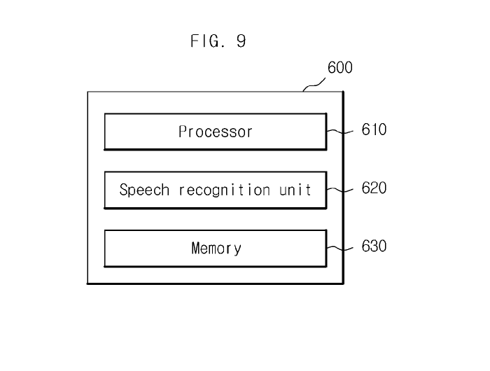

FIG. 9 is a block view illustrating an apparatus for detecting speech segment using a probabilistic model and hierarchical frame information of background noise according to an embodiment of the present invention.

Referring to FIG. 9, an apparatus 600 for detecting speech segment using a probabilistic model and hierarchical frame information of background noise according to an embodiment of the present invention may include a processor 610, a speech recognition unit 620 and a memory 630.

The speech recognition unit 610 may receive a speech signal. Here, the speech recognition unit 610 may be any means which is able to covert a speech signal to an electrical signal. The memory 620 may store program instructions to detect a speech segment and the processor 630 may execute the program instructions to detect a speech segment.

Here, the program instruction may include instructions to perform: obtaining a speech signal sample from the speech signal; calculating a mean and a standard deviation of the first T numbers of the speech signal sample; generating a frame by marking the speech signal sample with any one selected from a preliminary speech signal and a preliminary noise signal by using the mean and the standard deviation; classifying the frame into a plurality of sub-frames; obtaining a representative preliminary speech signal or a representative preliminary noise signal representing each sub-frame according to the number of the preliminary speech signal and the preliminary noise signal; determining the time changed from the representative preliminary noise signal to the representative preliminary speech signal as a starting time of the speech segment; determining the time changed from the representative preliminary speech signal to the representative preliminary noise signal as an ending time of the speech segment; and detecting the segment between the starting time of the speech segment and the ending time of the speech segment as the speech segment.

Exemplary embodiments relating to an application including the method for detecting speech segment described herein may be executed in one or more computer systems which can interact with various devices.

In an embodiment, the computer system may be a portable device, a personal computer system, a desktop computer, a laptop, a notebook or a netbook computer, a main frame computer system, a handheld computer, a workstation, a network computer, a camera, a set-top box, a mobile device, a consumer device, a video game device, an application server, a storage device, a switch, a modem, a router, or any type of a computing or electronic device but it is not limited thereto.

The computer system may include one or more processors connected to a system memory through an I/O interface. The computer system may further include a wire and/or wireless network interface connected to the I/O interface and also include one or more I/O devices which may be a cursor control device, a keyboard, display(s) or a multi-touch interface such as a r multi-touch-enabled device.

In an embodiment, the computer system may be implemented by using a single instance but a plurality of systems or a plurality of nodes configuring the computer system may be configured to host different components or instances of embodiments. For example, some components may be implemented through nodes implementing other components and one or more nodes of another computer system.

In various embodiments, the computer system may be a uni-processor system including one processor or a multi-processor system including more than one processors (e.g., 2, 4, 8 or the like). The processor may be any processor which is able to execute instructions. For example, in various embodiments, the processor may be a general or embedded processor implementing various ISAs such as x86, PowerPC, SPARC or MIPS instruction set architecture (ISA) or the like. In the multi-processor system, the processor may be generally, but not necessary, implemented by the same ISA.

In an embodiment, at least one processor may be a graphic processing unit. The graphic processing unit (GPU) may be considered as a personal computer, a workstation, a game console or an exclusive graphic rendering device for another computing or electrical device. Modern GPUs may be very effective in manipulating and displaying computer graphics and massively parallel architecture thereof may be more efficient for a desired range of complex graphic algorithms, compared with general GPUs. For example, the graphic processor may implement a plurality of graphic primitive operations much faster by a method executing graphic primitive operations, compared with direct drawing on a screen by using a host central processing unit (CPU).

In various embodiments, the methods and techniques described herein may be implemented at least partially by program instructions which are configured to execute in one or more of the GPUs in parallel. GPU may implement at least one application programmer interface (API) which is able to let a programmer bring functions of GPU. Appropriate GPUs may be purchased from vendors such as NVIDIA Corporation, ATI Technologies Inc. (AMD) and the like.

The system memory may be configured to store program instructions and/or data which are accessible by the processor. In various embodiments, the system memory may be implemented by using any appropriate memory technology such as static random access memory (SRAM), synchronous dynamic RAM (SDRAM), non-volatile/flash type memory or any other type of memory.

As described for embodiments of applications which implement the method for detecting speech segment using a probabilistic model and hierarchical frame information of background noise according to an embodiment of the present invention, program instructions and data which implement desired functions may be stored in a storage unit of program instructions and data in the system memory.

In other embodiments, program instructions and/or data may be received or transmitted or stored in a different type of computer-accessible medium or a similar medium separated from the system memory or the computer system. Generally, the computer-accessible medium may include a magnetic medium such as a disk connected to the computer system through an I/O interface or an optical medium such as CD/DVD-ROM, and a memory medium. Program instructions and data stored through the computer-accessible medium may be transmitted by transmission media or signals such as electric, electronic or digital signals which can be delivered through a communication medium such as network and/or wireless link.

In an embodiment, the I/O interface may be configured to control I/O traffics between peripheral devices including processors, system memories and network interfaces and/or other peripheral interfaces such as I/O devices. In some embodiments, the I/O interface may perform conversions of protocol, timing or other data in order to convert data signals by from one component (for example, a system memory) in an appropriate format to be used by another component (for example, a processor).

In an embodiment, the I/O interface may include support for attached devices through various types of peripheral buses such as modification of peripheral component interconnection (PCI) bus standard or universal serial bus (USB) standard. In some embodiments, function of the I/O interface may be divided into 2 or more of individual components such as a north bridge and a south bridge. In some embodiments, a part or all of functions of the I/O interface such as an interface for the system memory may be integrated directly in the processor.

The network interface may be configured to exchange data between devices or between nodes of the computer system.

In various embodiments, the network interface may support communication: through appropriate type of wire or wireless general purpose data networks such as Ethernet network; communication/mobile networks such as analog voice networks or digital optical fiber communication networks; storage area networks such as optical fiber channel SANs; or other appropriate types of networks and/or protocols.

In some embodiments, the I/O device may include at least one display terminal, keyboard, keypad, touchpad, scanning device, voice or optical recognition device, and devices suitable for inputting and searching data by at least one computer system. More than one I/O devices may be present in the computer system or distributed on various nodes of the computer system.

In an embodiment, similar I/O devices may be separated from the computer system or interact with at least one node of the computer system through wire or wireless connection such as a network interface.

The computer system and devices may be a computer, a personal computer system, a desktop computer, a laptop, a notebook or netbook computer, a main frame computer system, handheld computer, workstation, network computer, a camera, a set-top box, a mobile device, a network device, an internet appliance, PDA, a wireless phone, a pager, a consumer device, a video game console, a handheld video game device, an application server, a storage device, a switch, a modem, a peripheral device such as a router, or any type of a computing or electronic device or any combination of hardware and software.

The computer system may be connected to other devices or be operated as an independent system. In some embodiments, functions provided by components may be combined in smaller components or distributed in additional components. In some embodiments, functions of a part of components may not be provided and/or be available for other additional functions.

Various items are stored in the memory or in the storage unit while they are used but it is well understood to those of ordinary skill in the art that a part or all of those items may be transmitted between the memory and other storage devices for memory management and data storage. In other embodiments, all or a part of software components may be executed in memories of other devices and communicate with the computer system through the communication between computers.

All or a part of system components or data structures may be stored a computer-accessible medium which is to be read by an appropriate driver (for example, as instructions or structured data). In some embodiments, In some embodiments, instructions stored in the computer-accessible medium separated from the computer system may be transmitted to the computer system through a transmission medium or a signal.

The spirit of the present invention has been described by way of example hereinabove, and the present invention may be variously modified, altered, and substituted by those of ordinary skill in the art to which the present invention pertains without departing from essential features of the present invention.

What is claimed is:

1. A method for detecting speech segment comprising:
obtaining a speech signal sample from the speech signal;
calculating a mean and a standard deviation of the first T numbers of the speech signal sample;
generating a frame by marking the speech signal sample with any one selected from a preliminary speech signal and a preliminary noise signal by using the mean and the standard deviation;
classifying the frame into a plurality of sub-frames;
obtaining a representative preliminary speech signal or a representative preliminary noise signal representing each sub-frame according to the number of the preliminary speech signal and the preliminary noise signal; and
determining the time changed from the representative preliminary noise signal to the representative preliminary speech signal as a starting time of the speech segment.

2. The method for detecting speech segment of claim 1, further comprising
determining the time changed from the representative preliminary speech signal to the representative preliminary noise signal as an ending time of the speech segment; and
detecting the segment between the starting time of the speech segment and the ending time of the speech segment as the speech segment.

3. The method for detecting speech segment of claim 1, wherein the generating a frame comprises generating the frame by marking as the preliminary speech signal when an absolute value of a value obtained by subtracting the mean from a sample value of the speech signal sample is equal to or higher than N real number multiples of the standard deviation and marking as the preliminary noise signal when an absolute value of a value obtained by subtracting the mean from a sample value of the speech signal sample is less than N real number multiples of the standard deviation.

4. The method for detecting speech segment of claim 1, wherein the preliminary speech signal is marked with 1 and the preliminary noise signal is marked with 0.

5. A method for detecting speech segment comprising:
obtaining a speech signal sample from the speech signal;
calculating a mean and a standard deviation of the first T numbers of the speech signal sample;
generating a first frame by marking the speech signal sample with any one selected from a preliminary speech signal and a preliminary noise signal by using the mean and the standard deviation;
generating a second frame by classifying the first frame into a plurality of sub-frames and marking each of the sub-frames with a representative preliminary speech signal or a representative preliminary noise signal according to the number of the preliminary speech signal and the preliminary noise signal; and
determining the time changed from the signal marked with the preliminary noise signal to the signal marked with the preliminary speech signal at the second frame as a starting time of the speech segment.

6. The method for detecting speech segment of claim 5, further comprising:
determining the time changed from the signal marked with the preliminary speech signal to the signal marked with the preliminary noise signal at the second frame as an ending time of the speech segment; and
detecting the segment between the starting time of the speech segment and the ending time of the speech segment as the speech segment.

7. The method for detecting speech segment of claim 5, wherein the generating a first frame comprises generating the first frame by marking as the preliminary speech signal when an absolute value of a value obtained by subtracting the mean from a sample value of the speech signal sample is equal to or higher than N real number multiples of the standard deviation and marking as the preliminary noise signal when an absolute value of a value obtained by subtracting the mean from a sample value of the speech signal sample is less than N real number multiples of the standard deviation.

8. The method for detecting speech segment of claim 5, wherein the preliminary speech signal is marked with 1 and the preliminary noise signal is marked with 0.

9. An apparatus for detecting speech segment comprising:
at least one processor;
a speech signal recognition unit; and
a memory storing commands to detect speech segment from a speech signal comprising background noise segments and speech segments,
the commands comprises, when performed by the at least one processor, commands for the at least one processor to:
obtain a speech signal sample from the speech signal;
calculate a mean and a standard deviation of the first T numbers of the speech signal sample;
generate a frame by marking the speech signal sample with any one selected from a preliminary speech signal and a preliminary noise signal by using the mean and the standard deviation;
classify the frame into a plurality of sub-frames;
obtain a representative preliminary speech signal or a representative preliminary noise signal representing each sub-frame according to the number of the preliminary speech signal and the preliminary noise signal;
determine the time changed from the representative preliminary noise signal to the representative preliminary speech signal as a starting time of the speech segment;
determine the time changed from the representative preliminary speech signal to the representative preliminary noise signal as an ending time of the speech segment; and
detect the segment between the starting time of the speech segment and the ending time of the speech segment as the speech segment.

10. The apparatus for detecting speech segment of claim 9, wherein the commands comprises commands to generate the frame by marking as the preliminary speech signal when an absolute value of a value obtained by subtracting the mean from a sample value of the speech signal sample is equal to or higher than N real number multiples of the standard deviation and marking as the preliminary noise signal when an absolute value of a value obtained by subtracting the mean from a sample value of the speech signal sample is less than N real number multiples of the standard deviation.

11. The apparatus for detecting speech segment of claim 9, wherein the preliminary speech signal is marked with 1 and the preliminary noise signal is marked with 0.

12. An apparatus for detecting speech segment comprising:
at least one processor;
a speech signal recognition unit; and
a memory storing commands to detect speech segment from a speech signal comprising background noise segments and speech segments,
the commands comprises, when performed by the at least one processor, commands for the at least one processor to:
obtain a speech signal sample from the speech signal;
calculate a mean and a standard deviation of the first T numbers of the speech signal sample;
generate a first frame by marking the speech signal sample with any one selected from a preliminary speech signal and a preliminary noise signal by using the mean and the standard deviation;
classify the first frame into a plurality of sub-frames;
generate a second frame by marking each of the sub-frames with a representative preliminary speech signal or a representative preliminary noise signal according to the number of the preliminary speech signal and the preliminary noise signal; and
determine the time changed from the signal marked with the preliminary noise signal to the signal marked with the preliminary speech signal at the second frame as a starting time of the speech segment.

13. The apparatus for detecting speech segment of claim 12, wherein the commands comprises commands to:
determine the time changed from the signal marked with the preliminary speech signal to the signal marked with the preliminary noise signal at the second frame as an ending time of the speech segment; and
detect the segment between the starting time of the speech segment and the ending time of the speech segment as the speech segment.

14. The apparatus for detecting speech segment of claim 12, wherein the commands comprises commands to generate the first frame by marking as the preliminary speech signal when an absolute value of a value obtained by subtracting the mean from a sample value of the speech signal sample is equal to or higher than N real number multiples of the standard deviation and marking as the preliminary noise signal when an absolute value of a value obtained by subtracting the mean from a sample value of the speech signal sample is less than N real number multiples of the standard deviation.

15. The apparatus for detecting speech segment of claim 12, wherein the preliminary speech signal is marked with 1 and the preliminary noise signal is marked with 0.
